(19) United States
(12) Patent Application Publication
(10) Pub. No.: US 2022/0375314 A1
(43) Pub. Date: Nov. 24, 2022

(54) PROCESSING OF MEDIUM

(71) Applicant: Glory Ltd., Himeji (JP)

(72) Inventors: Junji MASHIMO, Himeji (JP); Yasushi KIMURA, Himeji (JP)

(73) Assignee: Glory Ltd., Himeji (JP)

(21) Appl. No.: 17/327,761

(22) Filed: May 24, 2021

(51) Int. Cl. G07F 19/00; G06Q 20/38; G06K 9/00

(52) U.S. Cl. CPC G07F 19/202; G06Q 20/381; G06K 9/00483; G07F 19/205; G07F 19/206; G07F 19/203

(57) ABSTRACT

A method for processing a medium includes: obtaining check information from an image of a check as the medium; and performing combined processing of deposit processing and exchange processing based on the check information, the combined processing including at least one of check deposit processing and check exchange processing.

### BACKGROUND

The present invention relates to processing of a medium.

In general, customers such as merchant customers may deposit their sales by checks, and may often exchange money after deposit. Therefore, there is a need for a method for efficiently performing deposit processing and exchange processing by a medium processing device that processes the checks.

### SUMMARY

According to an embodiment of the present invention, there is provided a method for processing a medium. The method includes: obtaining check information from an image of a check as the medium; and performing combined processing of deposit processing and exchange processing based on the check information. The combined processing includes at least one of check deposit processing and check exchange processing.

According to another embodiment of the present invention, there is provided a method for processing a medium. The method includes: obtaining check information from an image of a check as the medium; and performing check deposit processing and check exchange processing based on the check information by a single instruction of an operator. The check deposit processing is processing for depositing one part of an amount of the check, and the check exchange processing is processing for exchanging the other part of the amount of the check.

According to yet another embodiment of the present invention, there is provided an apparatus for processing a medium. The apparatus includes a processor and a memory coupled to the processor. The memory tangibly stores program instructions executable by the processor to cause the processor to perform a method including: obtaining check information from an image of a check as the medium; and performing combined processing of deposit processing and exchange processing based on the check information. The combined processing includes at least one of check deposit processing and check exchange processing.

### BRIEF DESCRIPTION OF THE DRAWINGS

FIG. 1 depicts a block diagram of a medium processing device according to a preferred exemplary embodiment of the present invention.

FIG. 2 depicts an example of a transaction menu displayed on a display device in the first operation.

FIG. 3 depicts an example of a deposit screen displayed on the display device in the first operation.

FIG. 4 depicts an example of an exchange screen displayed on the display device in the first operation.

FIG. 5 depicts an example of a receipt printed by a receipt printer in the first operation.

FIG. 6 depicts a flowchart representing an example of an operation when a controller displays received amounts of respective types of media on the deposit screen in the first operation.

FIG. 7 depicts a flowchart representing an example of an operation when a controller performs combined processing of deposit processing and exchange processing in the first operation.

FIG. 8 depicts an example of a deposit screen displayed on the display device in the second operation.

FIG. 9 depicts an example of an exchange screen displayed on the display device in the second operation.

FIG. 10 depicts a flowchart representing an example of an operation when a controller performs combined processing of deposit processing and exchange processing in the second operation.

### DETAILED DESCRIPTION

Hereinafter, exemplary embodiments of the present invention will be described in detail with reference to the attached drawings.

It is to be noted that the present invention is not limited to these exemplary embodiments to be given below and may be implemented with various modifications within the scope of the present invention. In addition, the drawings used herein are for purposes of illustration, and may not show actual dimensions.

In this specification, the term “customer” is used to mean a person who uses a service provided by the medium processing device.

Further, in this specification, the term “bill” is used to mean a paper currency and a polymer currency issued by a government or a central bank. The polymer currency means a currency including one or more polymer materials. While the paper currency and the polymer currency are also called a banknote, this description uses the term “bill” to refer to the paper currency and the polymer currency. The term “coin roll” is used to mean a bundle of a predetermined number of coins. While such a bundle is also called rolled coins, packed coins, a coin bar, and the like, this description uses the term “coin roll” to refer to the bundle.

Furthermore, in this specification, the term “check” is used to mean a security used by a drawer of the check to promise to pay a certain amount from the drawer's checking account. A holder of the check can cash the check at any time during bank business hours. The term “on-us check” is used to mean a check which is drawn on the same bank that the check is presented to for payment, and the term “not-on-us check” is used to mean a check which is drawn on another bank than that the check is presented to for payment.

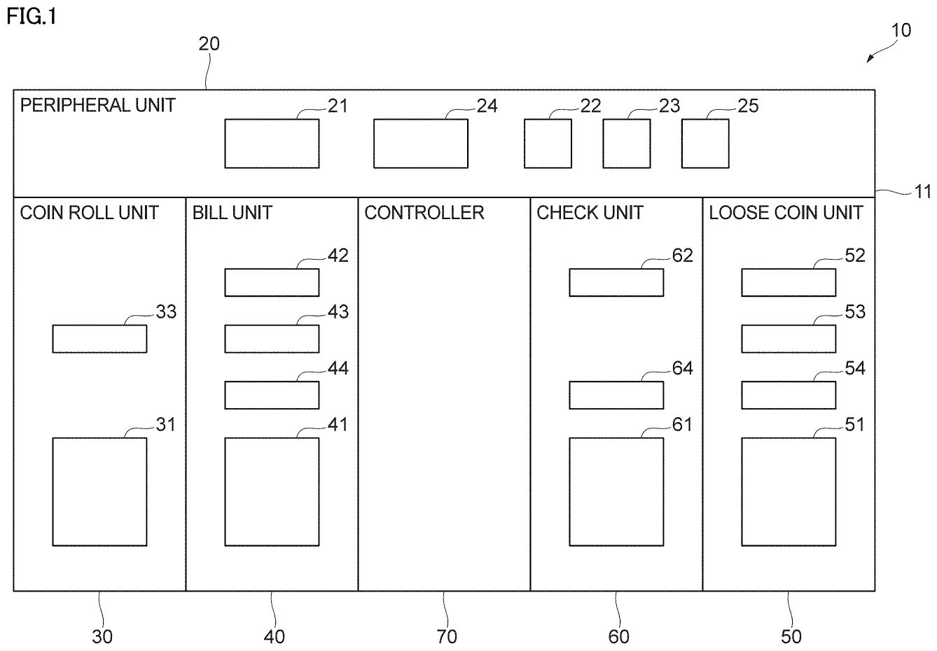

Referring to FIG. 1, there is shown a block diagram of a medium processing device 10 in accordance with a preferred exemplary embodiment. As shown in the figure, the medium processing device 10 may include a substantially cuboid housing 11, and a peripheral unit 20, a coin roll unit 30, a bill unit 40, a loose coin unit 50, a check unit 60, and a controller 70 may be installed inside the housing 11.

The peripheral unit 20 may perform peripheral processing such as input and output of information. More specifically, the peripheral unit 20 may include a display device 21, a card reader 22, a code reader 23, a pin pad 24, and a receipt printer 25.

The display device 21 may present information such as guide information, processing result information, and the like provided by the medium processing device 10 to a customer. The display device 21 may be a touch-screen device. The card reader 22 may read account information from a bank card carried by the customer. The code reader 23 may read a barcode, a QR Code® or the like from a payment form carried by the customer. The pin pad 24 may be operated by the customer to input personal identification number (PIN) information to the medium processing device 10. The receipt printer 25 may print and output a receipt including processing results of the medium processing device 10.

The coin roll unit 30 may process coin rolls. The coin roll unit 30 may take out the coin rolls stored inside the housing 11 to the outside of the housing 11. More specifically, the coin roll unit 30 may include coin roll storage cassettes 31 and a coin roll ejection port 33.

Each of the coin roll storage cassettes 31 may store plural coin rolls of a corresponding denomination. Each of the coin roll storage cassettes 31 may be manually loaded with the plural coin rolls as needed by an operator. In the figure, the coin roll storage cassettes 31 are shown by one square, but it is assumed that there are plural storage cassettes in the square. The coin roll ejection port 33 may eject coin rolls sent from any of the coin roll storage cassettes 31.

The bill unit 40 may process bills. The bill unit 40 may take in the bills from the outside to the inside of the housing 11, may identify and count the taken bills, and may store the taken bills inside the housing 11. In addition, the bill unit 40 may take out the bills stored inside the housing 11 to the outside of the housing 11. More specifically, the bill unit 40 may include bill storage cassettes 41, a bill reception port 42, a bill ejection port 43, and a bill discriminator 44.

Each of the bill storage cassettes 41 may store plural bills of a corresponding denomination. Each of the bill storage cassettes 41 may be manually loaded with the plural bills as needed by an operator. In the figure, the bill storage cassettes 41 are shown by one square, but it is assumed that there are plural storage cassettes in the square. The bill reception port 42 may receive the bills. The bill reception port 42 may be normally closed by a shutter (not shown), and when the customer commands the controller 70 to open the shutter according to the guide information displayed on the display device 21, the shutter may open and the bill reception port 42 may be opened. Thus, the bills may be inserted into the bill reception port 42 all at once. When the bills are taken in and then the checks are taken in, the bills may be taken in from the bill reception port 42 with the shutter thereof closed before the checks are taken in from a check reception port 62 (described later). The bill ejection port 43 may eject bills sent from any of the bill storage cassettes 41. The bill discriminator 44 may be provided in the middle of a conveyor for conveying the bills. The bill discriminator 44 may identify the denomination, authenticity, fitness, or the like of, and count the number of, the bills being conveyed from the bill reception port 42 to any of the bill storage cassettes 41 and the bills being conveyed from any of the bill storage cassettes 41 to the bill ejection port 43.

Note that the bill serves as one example of the claimed non-check. The bill reception port 42 serves as one example of the claimed reception port and the claimed second reception port.

The loose coin unit 50 may process loose coins. The loose coin unit 50 may take in the loose coins from the outside to the inside of the housing 11, may identify and count the taken loose coins, and may store the taken loose coins inside the housing 11. In addition, the loose coin unit 50 may take out the loose coins stored inside the housing 11 to the outside of the housing 11. More specifically, the loose coin unit 50 may include loose coin storage cassettes 51, a loose coin reception port 52, a loose coin ejection port 53, and a loose coin discriminator 54.

Each of the loose coin storage cassettes 51 may store plural loose coins of a corresponding denomination. Each of the loose coin storage cassettes 51 may be manually loaded with the plural loose coins as needed by an operator. In the figure, the loose coin storage cassettes 51 are shown by one square, but it is assumed that there are plural storage cassettes in the square. The loose coin reception port 52 may receive the loose coins. The loose coin reception port 52 may be normally closed by a shutter (not shown), and when the customer commands the controller 70 to open the shutter according to the guide information displayed on the display device 21, the shutter may open and the loose coin reception port 52 may be opened. Thus, the loose coins may be inserted into the loose coin reception port 52 all at once. When the loose coins are taken in and then the checks are taken in, the loose coins may be taken in from the loose coin reception port 52 with the shutter thereof closed before the checks are taken in from a check reception port 62 (described later). The loose coin ejection port 53 may eject loose coins sent from any of the loose coin storage cassettes 51. The loose coin discriminator 54 may be provided in the middle of a conveyor for conveying the loose coins. The loose coin discriminator 54 may identify and count the loose coins being conveyed from the loose coin reception port 52 to any of the loose coin storage cassettes 51 and the loose coins being conveyed from any of the loose coin storage cassettes 51 to the loose coin ejection port 53.

Note that the loose coin serves as one example of the claimed non-check. The loose coin reception port 52 serves as one example of the claimed reception port and the claimed second reception port.

The check unit 60 may process checks. The check unit 60 may take in the checks from the outside to the inside of the housing 11, may identify and count the taken checks, and may store the taken checks inside the housing 11. In addition, the check unit 60 may take out the checks stored inside the housing 11 to the outside of the housing 11. More specifically, the check unit 60 may include a check storage cassette 61, a check reception port 62, and a check discriminator 64.

The check storage cassette 61 may store plural checks. The check reception port 62 may receive the checks. The check reception port 62 may be normally closed by a shutter (not shown), and when the customer commands the controller 70 to open the shutter according to the guide information displayed on the display device 21, the shutter may open and the check reception port 62 may be opened. Thus, the checks may be inserted into the check reception port 62 all at once. When the checks are taken in and then the bills are taken in, the checks may be taken in from the check reception port 62 with the shutter thereof closed before the bills are taken in from the bill reception port 42. Alternatively, when the checks are taken in and then the loose coins are taken in, the checks may be taken in from the check reception port 62 with the shutter thereof closed before the loose coins are taken in from the loose coin reception port 52. The check discriminator 64 may be provided in the middle of a conveyor for conveying the checks. The check discriminator 64 may identify the checks being conveyed from the check reception port 62 to the check storage cassette 61. The check discriminator 64 may include a magnetic ink character reader (MICR) and a contact image sensor (CIS). The MICR may read magnetic ink characters printed on the checks. The magnetic ink characters may be used in printing amounts of the checks. The CIS may acquire an image on the check. The image may include identification information of an issuing institution (e.g., a bank) that has issued the check.

Note that the check reception port 62 serves as one example of the claimed reception port and the claimed first reception port.

In the above, the type of the medium and the reception port are in one-to-one correspondence, but this is merely exemplary. In an alternative embodiment, one reception port may receive plural types of media.

The controller 70 may be connected to the peripheral unit 20, the coin roll unit 30, the bill unit 40, the loose coin unit 50, and the check unit 60 by communication lines, and the controller 70 may control these units.

Specifically, the controller 70 may receive the image of the check from the check discriminator 64, and may obtain check information from the image. Then, the controller 70 may perform combined processing of deposit processing and exchange processing based on the check information. The combined processing may include combination of check deposit processing and check exchange processing.

Meanwhile, the combined processing may or may not include combination of non-check deposit processing and non-check exchange processing. The non-check deposit processing may include processing for deposit of the bills or the loose coins. The non-check exchange processing may include processing for exchanging with the bills or the coin rolls. In the following, the combined processing will be described as including the combination of the non-check deposit processing and the non-check exchange processing.

Further, the controller 70 may identify an executing institution executing the combined processing, and may identify an issuing institution issuing the check. Then, the controller 70 may perform the combined processing when the executing institution and the issuing institution match each other.

On the other hand, the controller 70 may not perform the combined processing when the executing institution and the issuing institution do not match each other. Alternatively, the controller 70 may perform the combined processing on condition that specific information is inputted, when the executing institution and the issuing institution do not match each other.

Next, operations of the medium processing device 10 will be described.

The operations of the medium processing device 10 may include, as a first operation, an operation of once depositing the entire amount of inputted media into an account and allocating a part of the deposited amount to exchange. Consequently, in the first operation, the exchange processing is almost the same as withdrawal processing.

The operations of the medium processing device 10 may include, as a second operation, an operation of exchanging a part of the amount of inputted media and depositing the remaining amount.

First, the first operation will be described.

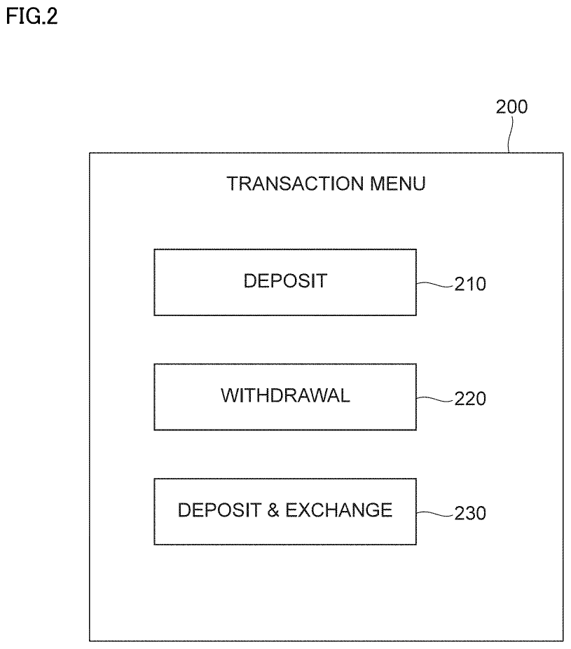

Referring to FIG. 2, there is shown an example of a transaction menu 200 displayed on the display device 21 in the first operation. As shown in the figure, the transaction menu 200 may include a deposit button 210, a withdrawal button 220, and a deposit and exchange button 230.

The deposit button 210 may be pressed by a customer when the customer requests the medium processing device 10 to perform deposit processing. The deposit button 210 serves as one example of the claimed first object for the deposit processing.

The withdrawal button 220 may be pressed by the customer when the customer requests the medium processing device 10 to perform withdrawal processing. The withdrawal button 220 serves as one example of the claimed second object for the exchange processing.

The deposit and exchange button 230 may be pressed by the customer when the customer requests the medium processing device 10 to perform combined processing of deposit processing and exchange processing. The deposit and exchange button 230 serves as one example of the claimed third object for the combined processing.

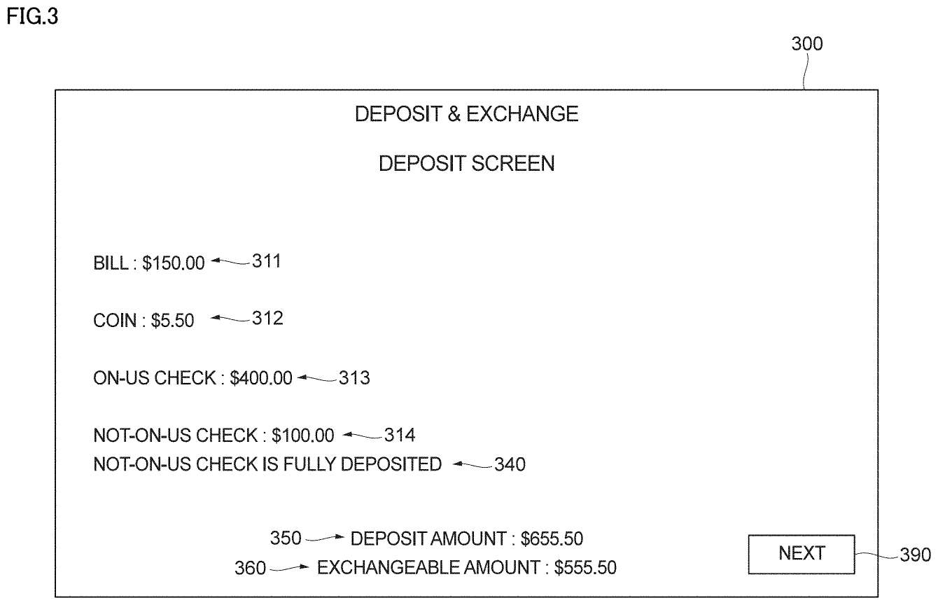

Referring to FIG. 3, there is shown an example of a deposit screen 300 that is displayed on the display device 21 when the deposit and exchange button 230 of FIG. 2 is pressed in the first operation. The deposit screen 300 may be operated by the customer to confirm a deposit amount to be deposited into the customer's account. As shown in the figure, the deposit screen 300 may include display texts 311 to 314, a display text 340, a display text 350, a display text 360, and a “NEXT” button 390.

Each of the display texts 311 to 314 may indicate a received amount of a corresponding type of the medium.

The display text 311 may indicate a received amount of bills. The received amount of bills may be an amount of bills received from the bill reception port 42. Information about the received amount of bills may be transmitted from the bill discriminator 44. In this example, the received amount of bills is assumed to be 150 dollars.

The display text 312 may indicate a received amount of coins. The received amount of coins may be an amount of loose coins received from the loose coin reception port 52. Information about the received amount of coins may be transmitted from the loose coin discriminator 54. In this example, the received amount of coins is assumed to be 5.5 dollars.

The display text 313 may indicate a received amount of on-us checks. The received amount of on-us checks may be an amount of on-us checks received from the check reception port 62. The received amount of on-us checks may be determined based on discrimination information transmitted from the check discriminator 64. The discrimination information may include a received amount of checks and information indicating that the checks have been issued by a bank in which the medium processing device 10 is installed. In this example, the received amount of on-us checks is assumed to be 400 dollars.

The display text 314 may indicate a received amount of not-on-us checks. The received amount of not-on-us checks may be an amount of not-on-us checks received from the check reception port 62. The received amount of not-on-us checks may be determined based on discrimination information transmitted from the check discriminator 64. The discrimination information may include a received amount of checks and information indicating that the checks have been issued by a bank other than a bank in which the medium processing device 10 is installed. In this example, the received amount of not-on-us checks is assumed to be 100 dollars.

Further, the display text 340 may indicate that the received amount of not-on-us checks is only eligible for the deposit processing. The not-on-us checks are not eligible for the exchange processing because credit for the checks cannot be confirmed immediately.

The display text 350 may indicate the total deposit amount. The total deposit amount may be obtained by adding the received amounts of bills, coins, on-us checks, and not-on-us checks. In this example, the total deposit amount is 655.5 dollars by adding 150 dollars, 5.5 dollars, 400 dollars, and 100 dollars.

The display text 360 may indicate an exchangeable amount. The exchangeable amount may be obtained by subtracting the received amount of not-on-us checks from the total deposit amount, since the received amount of not-on-us checks is not eligible for the exchange processing. In this example, the exchangeable amount is 555.5 dollars by subtracting 100 dollars from 655.5 dollars.

The “NEXT” button 390 may be pressed by the customer when the customer requests the medium processing device 10 to move on to the next screen.

In FIG. 3, the not-on-us checks are assumed not to be eligible for the exchange processing, but may be eligible for the exchange processing on condition that specific information is inputted. For example, the specific information may be a fee required to make the not-on-us checks eligible for the exchange processing. In this case, the exchangeable amount indicated by the display text 360 is equal to the total deposit amount indicated by the display text 350.

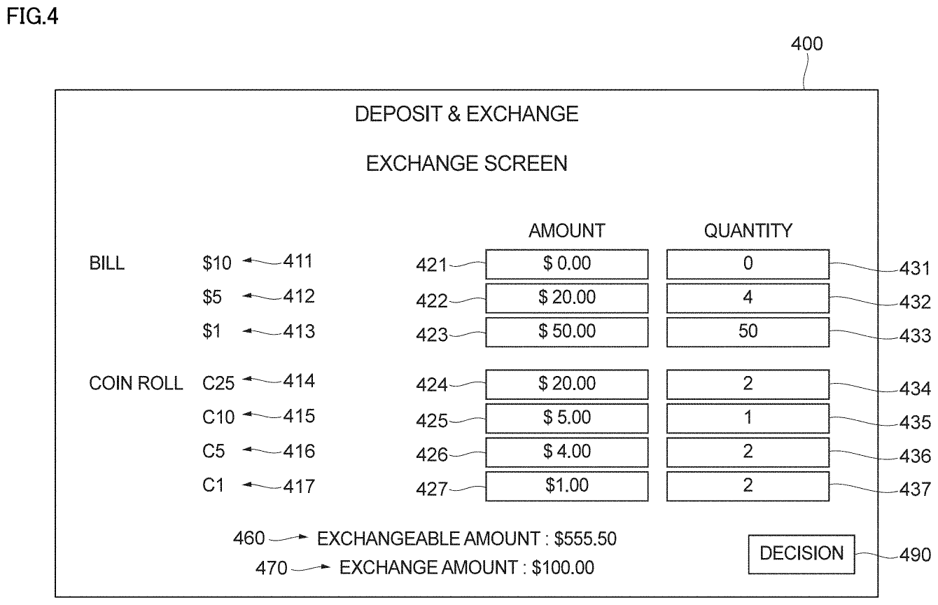

Referring to FIG. 4, there is shown an example of an exchange screen 400 that is displayed on the display device 21 when the “NEXT” button 390 of FIG. 3 is pressed in the first operation. The exchange screen 400 may be operated by the customer to designate pairs of a denomination and a quantity that the medium processing device 10 uses in the exchange processing. As shown in the figure, the exchange screen 400 may include display texts 411 to 417, display fields 421 to 427, input fields 431 to 437, a display text 460, a display text 470, and a decision button 490.

Each of the display texts 411 to 413 may indicate a corresponding denomination of bills. In this example, the display texts 411 to 413 indicate a ten dollar bill, a five dollar bill, and a one dollar bill, respectively. Each of the display texts 414 to 417 may indicate a corresponding denomination of coin rolls. In this example, the display texts 414 to 417 indicate a twenty-five cent coin roll, a ten cent coin roll, a five cent coin roll, and a one cent coin roll, respectively.

Each of the input fields 431 to 433 may be a field into which a quantity of the corresponding denomination of bills is inputted. In this example, numerals “0”, “4”, and “50” are assumed to be inputted into the input fields 431 to 433, respectively. Each of the input fields 434 to 437 may be a field into which a quantity of the corresponding denomination of coin rolls is inputted. In this example, numerals “2”, “1”, “2”, and “2” are assumed to be inputted into the input fields 434 to 437, respectively.

Each of the display fields 421 to 423 may be a field on which an exchange amount with the corresponding denomination of bills is displayed. In this example, a text indicating 0 dollars consisting of 0 ten dollar bills is displayed on the display field 421. A text indicating 20 dollars consisting of 4 five dollar bills is displayed on the display field 422. A text indicating 50 dollars consisting of 50 one dollar bills is displayed on the display field 423. Each of the display fields 424 to 427 may be a field on which an exchange amount with the corresponding denomination of coin rolls is displayed. In this example, a text indicating 20 dollars consisting of 2 twenty-five cent coin rolls (each including 40 twenty-five cent coins) is displayed on the display field 424. A text indicating 5 dollars consisting of 1 ten cent coin roll (including 50 ten cent coins) is displayed on the display field 425. A text indicating 4 dollars consisting of 2 five cent coin rolls (each including 40 five cent coins) is displayed on the display field 426. A text indicating 1 dollar consisting of 2 one cent coin rolls (each including 50 one cent coins) is displayed on the display field 427.

Further, the display text 460 may indicate the exchangeable amount. The exchangeable amount indicated by the display text 460 may be equal to the exchangeable amount indicated by the display text 360 of FIG. 3. In this example, the exchangeable amount is 555.5 dollars.

The display text 470 may indicate the exchange amount. The exchange amount may be obtained by adding the exchange amounts with ten dollar bills, five dollar bills, one dollar bills, twenty-five cent coin rolls, ten cent coin rolls, five cent coin rolls, and one cent coin rolls. In this example, the exchange amount is 100 dollars by adding 0 dollars, 20 dollars, 50 dollars, 20 dollars, 5 dollars, 4 dollars, and 1 dollar.

The decision button 490 may be pressed by the customer when the customer instructs the medium processing device 10 to perform the combined processing of the deposit processing and the exchange processing. The deposit processing may be processing for depositing the deposit amount indicated by the display text 350 of FIG. 3, and the exchange processing may be processing for exchanging the exchange amount indicated by the display text 470 of FIG. 4.

In FIG. 4, the exchange amount with each denomination is calculated by inputting a quantity of the denomination, but the exchange amount with each denomination may be directly inputted on the exchange screen 400.

Further, in FIG. 4, the exchange amount is determined based on information inputted on the exchange screen 400, but it may be determined based on preset information. For example, the preset information may include the exchange amount and pairs of a denomination and a quantity. On the other hand, the preset information may include only the exchange amount, and pairs of a denomination and a quantity may be inputted by the customer. Alternatively, the preset information may include a ratio of the exchange amount to the received amount. The preset information may be linked to customer identification information (i.e. a customer ID). For example, when the customer starts to operate the medium processing device 10, the preset information may be acquired by having the customer's bank card read by the card reader 22. The preset information may be stored in a memory (not shown) of the medium processing device 10, a server (not shown) connected with the medium processing device 10, or a card (not shown) to be inserted to the card reader 22.

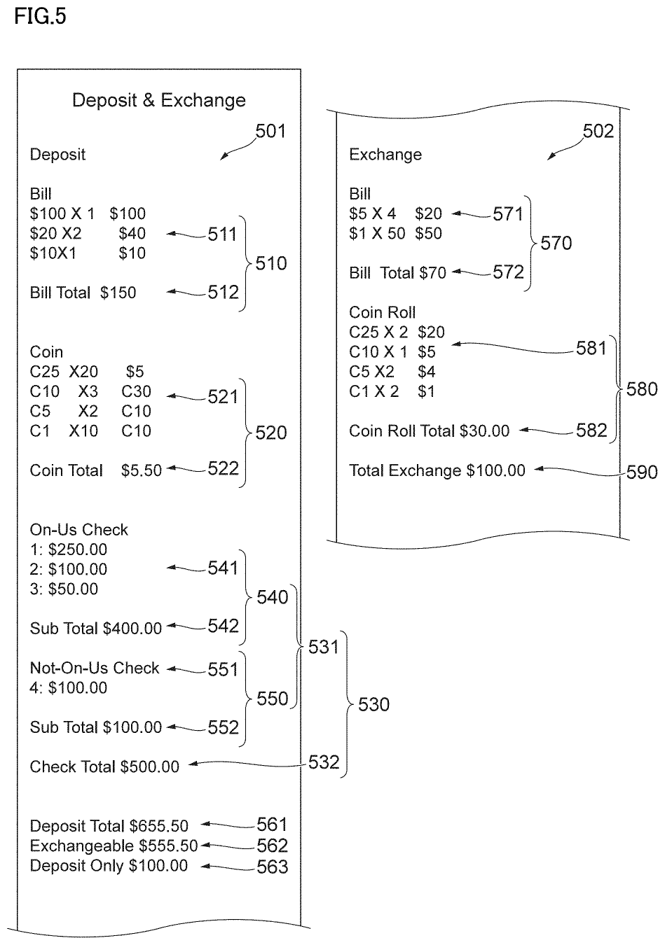

Referring to FIG. 5, there is shown an example of a receipt printed by the receipt printer 25 in the first operation. The receipt 500 is a small piece of paper provided to the customer to allow the customer to confirm transaction. As shown in the figure, the receipt 500 may include a deposit description 501 and an exchange description 502.

The deposit description 501 may include description blocks 510 to 530 and description texts 561 to 563.

The description block 510 may include description texts 511 and 512. The description text 511 may be a description about details of deposit of bills. In this example, the description text 511 indicates that 100 dollars have been deposited with 1 one hundred dollar bill, 40 dollars have been deposited with 2 twenty dollar bills, and 10 dollars have been deposited with 1 ten dollar bill. The description text 512 may be a description about a total deposit amount of bills. In this example, the description text 512 indicates that 150 dollars have been deposited with bills in total.

The description block 520 may include description texts 521 and 522. The description text 521 may be a description about details of deposit of coins. In this example, the description text 521 indicates that 5 dollars have been deposited with 20 twenty-five cent coins, 30 cents have been deposited with 3 ten cent coins, 10 cents have been deposited with 2 five cent coins, and 10 cents have been deposited with 10 one cent coins. The description text 522 may be a description about a total deposit amount of coins. In this example, the description text 522 indicates that 5.5 dollars have been deposited with coins in total.

The description block 530 may include a description block 531 and a description text 532.

The description block 531 may be a description about details of deposit of checks. The description block 531 may include description blocks 540 and 550.

The description block 540 may include description texts 541 and 542. The description text 541 may be a description about details of deposit of on-us checks. In this example, the description text 541 indicates that an on-us check for 250 dollars, an on-us check for 100 dollars, and an on-us check for 50 dollars have been deposited. The description text 542 may be a description about a total deposit amount of on-us checks. In this example, the description text 542 indicates that 400 dollars have been deposited with on-us checks in total.

The description block 550 may include description texts 551 and 552. The description text 551 may be a description about details of deposit of not-on-us checks. In this example, the description text 551 indicates that a not-on-us check for 100 dollars has been deposited. The description text 552 may be a description about a total deposit amount of not-on-us checks. In this example, the description text 552 indicates that 100 dollars have been deposited with a not-on-us check in total.

The description text 532 may be a description about a total deposit amount of checks. In this example, the description text 532 indicates that 500 dollars have been deposited with checks in total.

The description text 561 may be a description about a total deposit amount. In this example, the description text 561 indicates that a total of 655.5 dollars has been deposited, including bills, coins, and checks. The description text 562 may be a description about an exchangeable amount. In this example, the description text 562 indicates that 555.5 dollars out of 655.5 dollars are exchangeable. The description text 563 may be a description about an amount that can only be deposited. In this example, the description text 563 indicates that 100 dollars out of 655.5 dollars can only be deposited.

The exchange description 502 may include description blocks 570 and 580, and a description text 590.

The description block 570 may include description texts 571 and 572. The description text 571 may be a description about details of exchange with bills. In this example, the description text 571 indicates that 20 dollars have been exchanged with 4 five dollar bills, and 50 dollars have been exchanged with 50 one dollar bills. The description text 572 may be a description about a total exchange amount with bills. In this example, the description text 572 indicates that 70 dollars have been exchanged with bills in total.

The description block 580 may include description texts 581 and 582. The description text 581 may be a description about details of exchange with coin rolls. In this example, the description text 581 indicates that 20 dollars have been exchanged with 2 twenty-five cent coin rolls, 5 dollars have been exchanged with 1 ten cent coin roll, 4 dollars have been exchanged with 2 five cent coin rolls, and 1 dollar has been exchanged with 2 one cent coin rolls. The description text 582 may be a description about a total exchange amount with coin rolls. In this example, the description text 582 indicates that 30 dollars have been exchanged with coin rolls in total.

The description text 590 may be a description about a total exchange amount. In this example, the description text 590 indicates that 100 dollars have been exchanged, including bills and coin rolls.

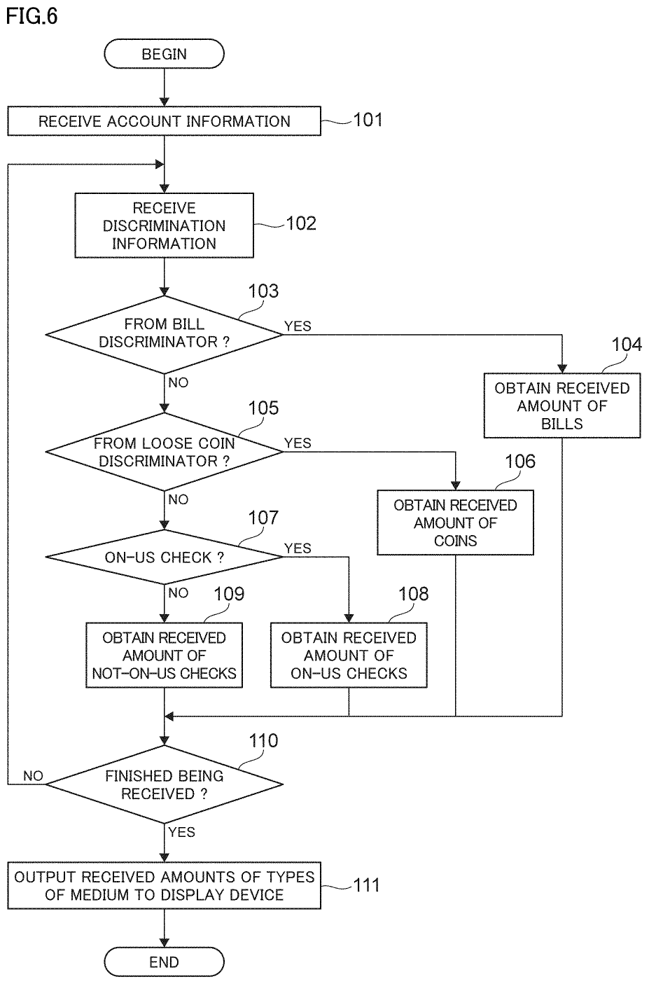

Referring to FIG. 6, there is shown a flowchart representing an example of an operation when the controller 70 displays received amounts of respective types of media on the deposit screen 300 of FIG. 3 in the first operation.

First, a customer may perform an operation of having the customer's bank card read by the card reader 22. In response to this operation, as shown in the figure, the controller 70 may receive account information of the customer from the card reader 22 (step 101).

Next, the customer may perform an operation of feeding bills from the bill reception port 42, feeding loose coins from the loose coin reception port 52, and feeding checks from the check reception port 62. In response to this operation, the controller 70 may receive discrimination information from any of the bill discriminator 44, the loose coin discriminator 54, and the check discriminator 64 (step 102).

The controller 70 may determine whether or not the discrimination information has been received from the bill discriminator 44 at step 102 (step 103).

If, at step 103, the discrimination information is determined to have been received from the bill discriminator 44, the controller 70 may obtain the received amount of bills (step 104). Specifically, the controller 70 may extract the received amount of bills from the discrimination information, and add the currently extracted received amount of bills to previously extracted received amounts of bills. On the other hand, if, at step 103, the discrimination information is not determined to have been received from the bill discriminator 44, the controller 70 may determine whether or not the discrimination information has been received from the loose coin discriminator 54 at step 102 (step 105).

If, at step 105, the discrimination information is determined to have been received from the loose coin discriminator 54, the controller 70 may obtain the received amount of coins (step 106). Specifically, the controller 70 may extract the received amount of coins from the discrimination information, and add the currently extracted received amount of coins to previously extracted received amounts of coins. On the other hand, if, at step 105, the discrimination information is not determined to have been received from the loose coin discriminator 54, namely, if, at step 105, the discrimination information is determined to have been received from the check discriminator 64, the controller 70 may determine whether or not the discrimination information indicates that a check discriminated by the check discriminator 64 is an on-us check (step 107). Specifically, the controller 70 may determine whether or not an issuing institution issuing the check and an executing institution executing processing of the check match each other. In other words, the controller 70 may determine whether or not the issuing institution and the institution where the medium processing device 10 is installed match each other.

If, at step 107, the discrimination information is determined to indicate that the check is an on-us check, the controller 70 may obtain the received amount of the on-us check (step 108). Specifically, the controller 70 may extract the received amount of the on-us check from the discrimination information, and add the currently extracted received amount of the on-us check to previously extracted received amounts of on-us checks. On the other hand, if, at step 107, the discrimination information is not determined to indicate that the check is an on-us check, namely, if, at step 107, the discrimination information is determined to indicate that the check is a not-on-us check, the controller 70 may obtain the received amount of the not-on-us check (step 109). Specifically, the controller 70 may extract the received amount of the not-on-us check from the discrimination information, and add the currently extracted received amount of the not-on-us check to previously extracted received amounts of not-on-us checks.

After that, the controller 70 may determine whether or not the discrimination information has finished being received (step 110).

If, at step 110, the discrimination information is not determined to have finished being received, the controller 70 may advance the process to step 102. On the other hand, if, at step 110, the discrimination information is determined to have finished being received, the controller 70 may output the received amounts of the respective types of media to the display device 21 to display them on the deposit screen 300 of FIG. 3 (step 111).

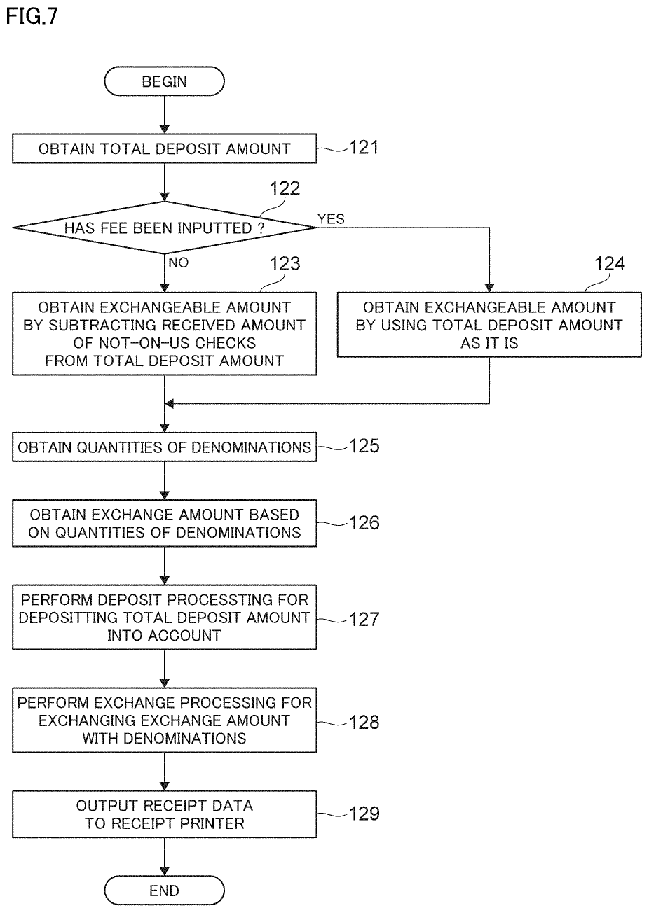

Referring to FIG. 7, there is shown a flowchart representing an example of an operation when the controller 70 determines the deposit amount and the exchange amount, and performs the combined processing of the deposit processing and the exchange processing in the first operation. In the following, the fee will be described as an example of the specific information.

As shown in the figure, the controller 70 may obtain the total deposit amount by adding the received amounts of the respective types of media (step 121). The total deposit amount may be thus outputted to the display device 21. Then, the total deposit amount may be displayed as the display text 350 on the deposit screen 300 of FIG. 3.

Next, the controller 70 may determine whether or not a fee has been inputted (step 122).

If, at step 122, the fee is not determined to have been inputted, the controller 70 may obtain the exchangeable amount by subtracting the received amount of not-on-us checks from the total deposit amount (step 123). The exchangeable amount may be thus outputted to the display device 21. Then, the exchangeable amount may be displayed as the display text 360 on the deposit screen 300 of FIG. 3, and may be displayed as the display text 460 on the exchange screen 400 of FIG. 4 after the “NEXT” button 390 is pressed.

On the other hand, if, at step 122, the fee is determined to have been inputted, the controller 70 may obtain the exchangeable amount by using the total deposit amount as it is (step 124). The exchangeable amount may be thus outputted to the display device 21.

Next, the customer may perform an operation of inputting quantities of denominations on the exchange screen 400 of FIG. 4. In response to this operation, the controller 70 may obtain the quantities of the denominations (step 125).

Subsequently, the controller 70 may obtain the exchange amount based on the quantities of the denominations obtained at step 125 (step 126). Specifically, the controller 70 may obtain the exchange amount by adding the exchange amounts with the denominations displayed on the display fields 421 to 427. The exchange amount may be thus outputted to the display device 21. Then, the exchange amount may be displayed as the display text 470 on the exchange screen 400 of FIG. 4.

After that, the customer may perform an operation of pressing the decision button 490. In response to this operation, the controller 70 may perform the deposit processing for depositing the total deposit amount into the customer's account (step 127). The total deposit amount may be obtained at step 121, and the customer's account may be specified by the account information received at step 101 of FIG. 6. At this time, the controller 70 may perform the deposit processing for depositing the total deposit amount into the customer's plural accounts.

Next, the controller 70 may perform the exchange processing for exchanging the exchange amount with the quantities of the denominations (step 128). The exchange amount may be obtained at step 126, and the quantities of the denominations may be obtained at step 125.

Finally, the controller 70 may output receipt data to the receipt printer 25 (step 129). The receipt of FIG. 5 may be thus printed by the receipt printer 25.

Next, the second operation will be described.

Since an example of a transaction menu displayed on the display device 21 in the second operation is the same as the transaction menu 200 of FIG. 2, the description thereof will be omitted.

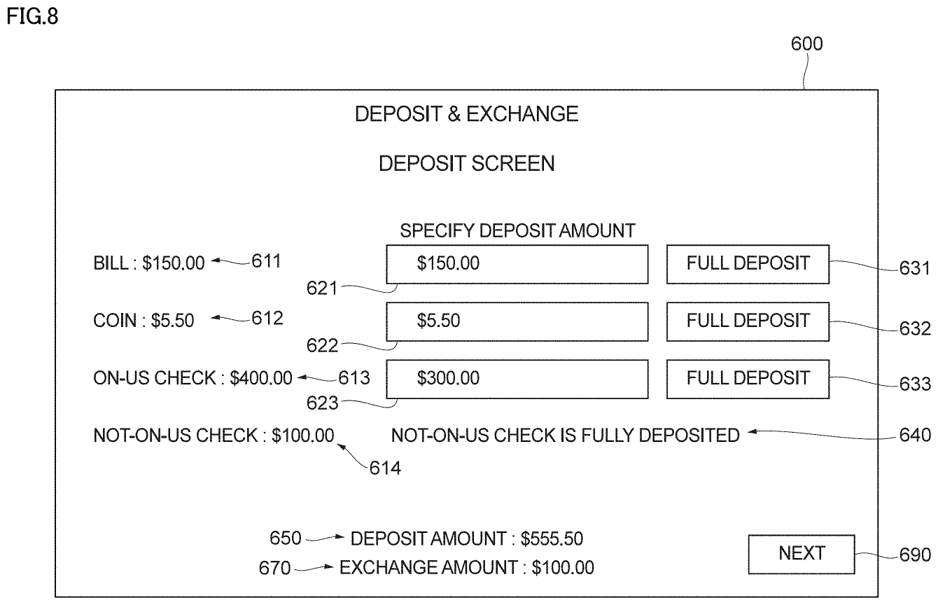

Referring to FIG. 8, there is shown an example of a deposit screen 600 that is displayed on the display device 21 when the deposit and exchange button 230 of FIG. 2 is pressed in the second operation. The deposit screen 600 may be operated by a customer to designate a deposit amount to be deposited into the customer's account. As shown in the figure, the deposit screen 600 may include display texts 611 to 614, input fields 621 to 623, full deposit buttons 631 to 633, a display text 640, a display text 650, a display text 670, and a “NEXT” button 690.

Each of the display texts 611 to 614 may indicate a received amount of a corresponding type of the medium.

The display text 611 may indicate a received amount of bills. The received amount of bills may be an amount of bills received from the bill reception port 42. Information about the received amount of bills may be transmitted from the bill discriminator 44. In this example, the received amount of bills is assumed to be 150 dollars.

The display text 612 may indicate a received amount of coins. The received amount of coins may be an amount of loose coins received from the loose coin reception port 52. Information about the received amount of coins may be transmitted from the loose coin discriminator 54. In this example, the received amount of coins is assumed to be 5.5 dollars.

The display text 613 may indicate a received amount of on-us checks. The received amount of on-us checks may be an amount of on-us checks received from the check reception port 62. The received amount of on-us checks may be determined based on discrimination information transmitted from the check discriminator 64. The discrimination information may include a received amount of checks and information indicating that the checks have been issued by a bank in which the medium processing device 10 is installed. In this example, the received amount of on-us checks is assumed to be 400 dollars.

The display text 614 may indicate a received amount of not-on-us checks. The received amount of not-on-us checks may be an amount of not-on-us checks received from the check reception port 62. The received amount of not-on-us checks may be determined based on discrimination information transmitted from the check discriminator 64. The discrimination information may include a received amount of checks and information indicating that the checks have been issued by a bank other than a bank in which the medium processing device 10 is installed. In this example, the received amount of not-on-us checks is assumed to be 100 dollars.

Each of the input fields 621 to 623 may be a field into which a deposit amount of a corresponding type of the medium is inputted.

The input field 621 may be a field into which a deposit amount of bills is inputted. In this example, a text indicating 150 dollars is inputted into the input field 621 to specify that the received amount of bills is to be fully deposited. The customer may also press the full deposit button 631 to specify that the received amount of bills is to be fully deposited.

The input field 622 may be a field into which a deposit amount of coins is inputted. In this example, a text indicating 5.5 dollars is inputted into the input field 622 to specify that the received amount of coins is to be fully deposited. The customer may also press the full deposit button 632 to specify that the received amount of coins is to be fully deposited.

The input field 623 may be a field into which a deposit amount of on-us checks is inputted. In this example, a text indicating 300 dollars is inputted into the input field 623 to specify that 300 dollars out of 400 dollars, which are the received amount of on-us checks, are to be deposited.

Further, the display text 640 may indicate that the received amount of not-on-us checks is only eligible for the deposit processing. The not-on-us checks are not eligible for the exchange processing because credit for the checks cannot be confirmed immediately.

The display text 650 may indicate the total deposit amount. The total deposit amount may be obtained by adding the deposit amounts of bills, coins, and on-us checks inputted into input fields 621 to 623, and the received amount of not-on-us checks indicated by the display text 614. In this example, the total deposit amount is 555.5 dollars by adding 150 dollars, 5.5 dollars, 300 dollars, and 100 dollars.

The display text 670 may indicate an exchange amount. The exchange amount may be obtained by subtracting the deposit amount of bills, coins, and on-us checks inputted into input fields 621 to 623 from the received amount of bills, coins, and on-us checks indicated by the display texts 611 to 613. In this example, the exchange amount is 100 dollars by subtracting the sum of 150 dollars, 5.5 dollars, and 300 dollars inputted into the input fields 621 to 623 from the sum of 150 dollars, 5.5 dollars, and 400 dollars indicated by the display texts 611 to 613.

The “NEXT” button 690 may be pressed by the customer when the customer requests the medium processing device 10 to move on to the next screen.

In FIG. 8, the not-on-us checks are assumed not to be eligible for the exchange processing, but may be eligible for the exchange processing on condition that specific information is inputted. For example, the specific information may be a fee required to make the not-on-us checks eligible for the exchange processing. In this case, an input field and a full deposit button are also displayed for the not-on-us checks on the deposit screen 600 of FIG. 8.

Further, in FIG. 8, the deposit amount is determined based on information inputted on the deposit screen 600, but it may be determined based on preset information. For example, the preset information may include the deposit amount and types of media. On the other hand, the preset information may include only the deposit amount, and types of media may be inputted by the customer. Alternatively, the preset information may include a ratio of the deposit amount to the received amount.

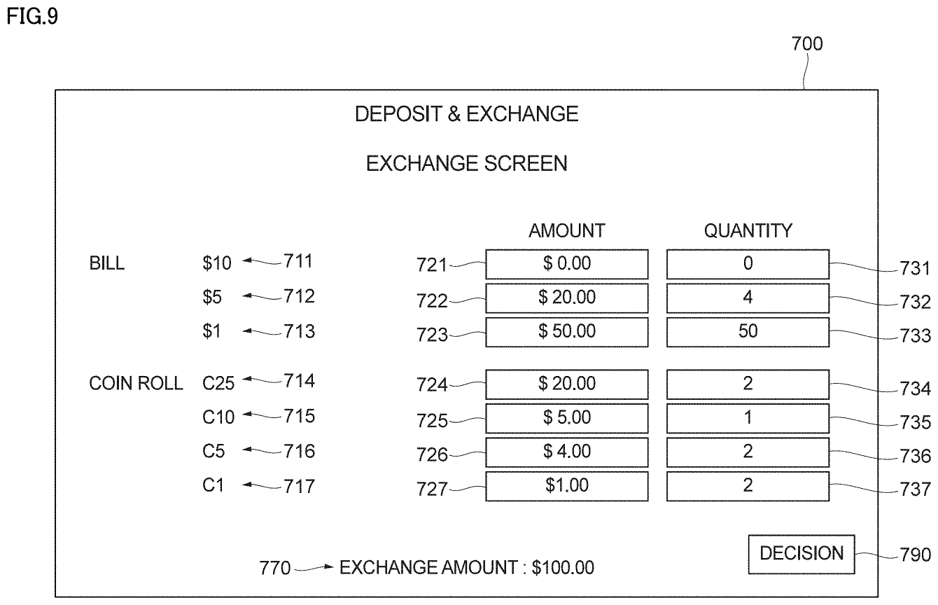

Referring to FIG. 9, there is shown an example of an exchange screen 700 that is displayed on the display device 21 when the “NEXT” button 690 of FIG. 8 is pressed in the second operation. The exchange screen 700 may be operated by the customer to designate pairs of a denomination and a quantity that the medium processing device 10 uses in the exchange processing. As shown in the figure, the exchange screen 700 may include display texts 711 to 717, display fields 721 to 727, input fields 731 to 737, a display text 770, and a decision button 790.

The display texts 711 to 717, the display fields 721 to 727, and the input fields 731 to 737 are the same as the display texts 411 to 417 of FIG. 4, the display fields 421 to 427 of FIG. 4, and the input fields 431 to 437 of FIG. 4, respectively, and thus the description thereof will be omitted.

The display text 770 may indicate the exchange amount. The exchange amount indicated by the display text 770 may be equal to the exchange amount indicated by the display text 670 of FIG. 8. In this example, the exchange amount is 100 dollars.

The decision button 790 may be pressed by the customer when the customer instructs the medium processing device 10 to perform the combined processing of the deposit processing and the exchange processing. The deposit processing may be processing for depositing the deposit amount indicated by the display text 650 of FIG. 8, and the exchange processing may be processing for exchanging the exchange amount indicated by the display text 770.

Since an example of an operation when the controller 70 displays received amounts of the respective types of media on the deposit screen 600 of FIG. 8 in the second operation is the same as the example of the operation of FIG. 6, the description thereof will be omitted.

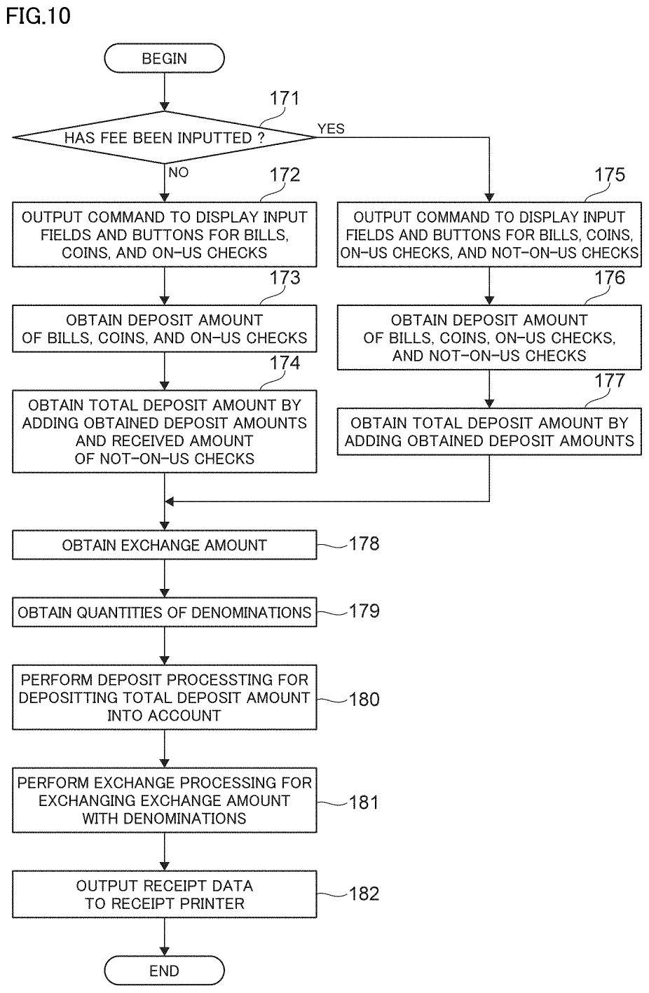

Referring to FIG. 10, there is shown a flowchart representing an example of an operation when the controller 70 determines the deposit amount and the exchange amount, and performs the combined processing of the deposit processing and the exchange processing in the second operation. In the following, the fee will be described as an example of the specific information.

As shown in the figure, the controller 70 may determine whether or not a fee has been inputted (step 171).

If, at step 171, the fee is not determined to have been inputted, the controller 70 may output a command to display input fields and full deposit buttons for bills, coins, and on-us checks (step 172). Then, the input fields 621 to 623 and the full deposit buttons 631 to 633 may be displayed on the deposit screen 600. Next, the customer may perform an operation of inputting deposit amounts of bills, coins, and on-us checks into the input fields 621 to 623, respectively. In response to this operation, the controller 70 may obtain the deposit amounts of bills, coins, and on-us checks (step 173). Thus, the controller 70 may obtain the total deposit amount by adding the deposit amounts of bills, coins, and on-us checks obtained at step 173, and the received amount of not-on-us checks indicated by the display text 614 (step 174). The total deposit amount may be thus outputted to the display device 21. Then, the total deposit amount may be displayed as the display text 650 on the deposit screen 600 of FIG. 8.

On the other hand, if, at step 171, the fee is determined to have been inputted, the controller 70 may output a command to display input fields and full deposit buttons for bills, coins, on-us checks, and not-on-us checks (step 175). Then, the input fields and the full deposit buttons for the bills, the coins, the on-us checks, and the not-on-us checks may be displayed on the deposit screen 600. Next, the customer may perform an operation of inputting deposit amounts of bills, coins, on-us checks, and not-on-us checks into the input fields for the bills, the coins, the on-us checks, and the not-on-us checks, respectively. In response to this operation, the controller 70 may obtain the deposit amounts of bills, coins, on-us checks, and not-on-us checks (step 176). Thus, the controller 70 may obtain the total deposit amount by adding the deposit amounts of bills, coins, on-us checks, and not-on-us checks obtained at step 176 (step 177). The total deposit amount may be thus outputted to the display device 21.

Next, the controller 70 may obtain the exchange amount by subtracting the total deposit amount obtained at step 174 or 177 from the sum of the received amounts obtained at steps 104, 106, 108 and 109 of FIG. 6 (step 178). By this, the exchange amount may be outputted to the display device 21. Then, the exchange amount may be displayed as the display text 670 on the deposit screen 600 of FIG. 8, and may be displayed as the display text 770 on the exchange screen 700 of FIG. 9 after the “NEXT” button 690 is pressed.

Subsequently, the customer may perform an operation of inputting quantities of denominations on the exchange screen 700 of FIG. 9. In response to this operation, the controller 70 may obtain the quantities of the denominations (step 179).

After that, the customer may perform an operation of pressing the decision button 790. In response to this operation, the controller 70 may perform the deposit processing for depositing the total deposit amount into the customer's account (step 180). The total deposit amount may be obtained at step 174 or 177, and the customer's account may be specified by the account information received at step 101 of FIG. 6. At this time, the controller 70 may perform the deposit processing for depositing the total deposit amount into the customer's plural accounts.

Next, the controller 70 may perform the exchange processing for exchanging the exchange amount with the quantities of the denominations (step 181). The exchange amount may be obtained at step 178, and the quantities of the denominations may be obtained at step 179.

Finally, the controller 70 may output receipt data to the receipt printer 25 (step 182). A receipt based on the receipt data may be thus printed by the receipt printer 25.

In this example of the operation, the controller 70 performs the deposit processing and, after that, performs the exchange processing in the combined processing, but the execution procedure of the deposit processing and the exchange processing is not limited to this. For example, the controller 70 may perform the exchange processing and, after that, perform the deposit processing. Alternatively, the controller 70 may perform the deposit processing and the exchange processing in parallel. In other words, in the combined processing, the deposit processing and the exchange processing may be performed by a single instruction of a customer, who is an example of an operator.

In the above embodiment, the medium processing device 10 allocates checks for both of deposit and exchange, but this is merely exemplary. The medium processing device 10 may allocate checks only for deposit and non-checks for exchange. Alternatively, the medium processing device 10 may allocate checks only for exchange and non-checks for deposit. In addition, the medium processing device 10 may only exchange checks without making deposit.

In the above embodiment, the medium processing device 10 takes in the checks, but the medium processing device 10 does not have to take in the checks. For example, the medium processing device 10 may obtain only images of the checks acquired by another device, and may perform processing based on the images. For example, the images of the checks may be acquired by a smartphone as another device. In this case, the deposit processing and/or the exchange processing as to the checks can be done without the checks as the medium.

In the above embodiment, all of the medium to be processed by the medium processing device 10, the medium to be allocated for the deposit processing, and the medium to be allocated for the exchange processing are checks and non-checks, but this is merely exemplary.

For example, the medium to be processed by the medium processing device 10 may be only checks. In this case, both the medium to be allocated for the deposit processing and the medium allocated for the exchange processing may be only checks.

Alternatively, in the case where the medium to be processed by the medium processing device 10 is checks and non-checks, the following may be performed. First, when the medium to be allocated for the deposit processing is checks and non-checks, the medium to be allocated for the exchange processing may be only checks or only non-checks. Second, when the medium to be allocated for the exchange processing is checks and non-checks, the medium to be allocated for the deposit processing may be only checks or only non-checks. Third, both the medium to be allocated for the deposit processing and the medium to be allocated for the exchange processing may be only checks. In this case, when non-checks may be inserted with checks into the medium processing device 10, non-checks may be allocated for a processing (for example, remittance) except the deposit processing and the exchange processing. Fourth, the medium to be allocated for the deposit processing and the medium to be allocated for the exchange processing may be only checks and only non-checks, respectively. Fifth, the medium to be allocated for the deposit processing and the medium to be allocated for the exchange processing may be only non-checks and only checks, respectively.

In summary, the combined processing of deposit processing and exchange processing may include at least one of the check deposit processing and the check exchange processing, and may further include at least one of the non-check deposit processing and the non-check exchange processing.

What is claimed is:

1. A method for processing a medium, the method comprising:
obtaining check information from an image of a check as the medium; and
performing combined processing of deposit processing and exchange processing based on the check information, the combined processing including at least one of check deposit processing and check exchange processing.

2. The method of claim 1, further comprising:
identifying an executing institution executing the combined processing;
identifying an issuing institution issuing the check; and
performing the combined processing when the executing institution and the issuing institution match each other.

3. The method of claim 2, wherein the issuing institution is identified from the image of the check.

4. The method of claim 1, further comprising:
identifying an executing institution executing the combined processing;
identifying an issuing institution issuing the check; and
performing the combined processing on condition that specific information is inputted, when the executing institution and the issuing institution do not match each other.

5. The method of claim 4, wherein the specific information is information about a fee.

6. The method of claim 1, further comprising taking in the check and a non-check as the medium from a reception port.

7. The method of claim 6, wherein the non-check includes at least one of a bill and a coin.

8. The method of claim 6, wherein the combined processing further includes at least one of non-check deposit processing and non-check exchange processing.

9. The method of claim 6, wherein the combined processing does not include combination of non-check deposit processing and non-check exchange processing.

10. The method of claim 6, wherein
the reception port includes a first reception port and a second reception port, and
the check is taken in from the first reception port, and the non-check is taken in from the second reception port.

11. The method of claim 10, wherein the non-check is taken in from the second reception port with a shutter thereof closed, and then the check is taken in from the first reception port.

12. The method of claim 10, wherein the check is taken in from the first reception port with a shutter thereof closed, and then the non-check is taken in from the second reception port.

13. The method of claim 1, wherein
the check deposit processing is processing for depositing a deposit amount of money determined based on preset information, and
the check exchange processing is processing for exchanging an exchange amount of money obtained by subtracting the deposit amount of money from an amount of the check.

14. The method of claim 1, wherein
the check exchange processing is processing for exchanging an exchange amount of money determined based on preset information, and
the check deposit processing is processing for depositing a deposit amount of money obtained by subtracting the exchange amount of money from an amount of the check.

15. The method of claim 1, wherein the check exchange processing includes processing for ejecting an exchange amount of money in a designated denomination and quantity.

16. The method of claim 1, wherein the check deposit processing includes processing for depositing a deposit amount of money into a plurality of accounts.

17. The method of claim 1, further comprising:
displaying a menu including a first object for the deposit processing, a second object for the exchange processing, and a third object for the combined processing; and
performing the combined processing in response to selection of the third object.

18. The method of claim 1, wherein the combined processing is processing in which the deposit processing and the exchange processing are performed by a single instruction of an operator.

19. A method for processing a medium, the method comprising:
obtaining check information from an image of a check as the medium; and
performing check deposit processing and check exchange processing based on the check information by a single instruction of an operator, the check deposit processing being processing for depositing one part of an amount of the check, the check exchange processing being processing for exchanging the other part of the amount of the check.

20. An apparatus for processing a medium, the apparatus comprising:
a processor; and
a memory coupled to the processor, wherein
the memory tangibly stores program instructions executable by the processor to cause the processor to perform a method comprising:
obtaining check information from an image of a check as the medium; and
performing combined processing of deposit processing and exchange processing based on the check information, the combined processing including at least one of check deposit processing and check exchange processing.
